(19) United States
(12) Patent Application Publication
(10) Pub. No.: US 2016/0134719 A1
(43) Pub. Date: May 12, 2016

(54) METHODS AND SYSTEMS FOR DISPLAYING GRAPHIC REPRESENTATIONS IN A USER INTERFACE

(71) Applicant: Bubboe Corporation, Taipei City (TW)

(72) Inventors: John C. Wang, Taipei City (TW); Chieh Yang, Taipei City (TW); Yi-An Hou, Taipei City (TW); Chih-Feng Hsu, Taipei City (TW)

(21) Appl. No.: 14/930,756

(22) Filed: Nov. 3, 2015

(30) Foreign Application Priority Data
Nov. 12, 2014 (TW) 103139171

(51) Int. Cl. H04L 29/08; H04W 72/08; H04W 4/02; G06F 3/0481

(52) U.S. Cl. CPC H04L 67/2823; G06F 3/0481; H04W 72/085; H04W 4/023; H04L 67/18; G06F 2203/04803

(57) ABSTRACT

Methods and systems for displaying graphic representations in a user interface are provided. First, a wireless signal generated by at least one specific electronic device is detected via a wireless network. Then, a signal strength of the wireless signal is obtained, and a visual representation manner of a graphic representation corresponding to the specific electronic device is determined according to the signal strength. Then, the graphic representation is displayed in a user interface via a display unit.

### BACKGROUND OF THE INVENTION

1. Field of the Invention

The disclosure relates generally to methods and systems for displaying graphic representations in a user interface, and, more particularly to methods and systems that can display a graphic representation corresponding to a specific electronic device in a user interface according to a received wireless signal.

2. Description of the Related Art

Recently, electronic devices, such as smart phones, tablets, notebooks, and other portable devices, have become more and more technically advanced and multifunctional. For example, portable devices have network connectivity capabilities. Users can use their portable devices to connect to networks at anytime and anywhere. The convenience and new functionalities advanced by modern technology have made these devices into necessities of life.

Furthermore, with the coming of IOT (Internet Of Things) generation, every device or object can connect to networks, and users can access and control these devices or objects via networks. The rapid development of IOT is fortunate that the underlying foundation of wireless network technology is already very mature. Electronic devices can readily connect with each other to perform related applications via wireless networks. Additionally, the BLE (Bluetooth Low Energy) technology has solved the prohibitive power consumption issue caused by prolonged connections of electronic devices to wireless networks.

Although networking and power consumption issues have been largely resolved, there still exists room for improvement with regards to how IOT devices communicate with other networked devices. For example, a beacon device is a low-cost wireless Bluetooth transmitter implemented with BLE technology, which can transmit Bluetooth signals via a wireless network for a long time. A mobile phone implemented with BLE technology can wirelessly seek Bluetooth signals to discover corresponding beacon device. The mobile phone can use figures or text to represent whether a specific beacon device has been detected. However, when several beacon devices are present in an environment, a user cannot recognize the location of the respective beacon devices, nor is there a simple way to identify the distance between you and the users associated with the respective beacon devices.

### BRIEF SUMMARY OF THE INVENTION

Methods and systems for displaying graphic representations in a user interface are provided, wherein a graphic representation corresponding to a specific electronic device can be displayed in a user interface according to a received wireless signal.

In an embodiment of a method for displaying graphic representations in a user interface, a wireless signal generated by at least one specific electronic device is detected via a wireless network. Then, a signal strength of the wireless signal is obtained, and a visual representation manner of a graphic representation corresponding to the specific electronic device is determined according to the signal strength. Then, the graphic representation is displayed in a user interface via a display unit.

An embodiment of a system for displaying graphic representations in a user interface comprises a display unit, a wireless connecting unit, and a processing unit. The display unit displays a user interface. The wireless connecting unit detects a wireless signal generated by at least one specific electronic device via a wireless network. The processing unit obtains a signal strength of the wireless signal, and determines a visual representation manner of a graphic representation corresponding to the specific electronic device according to the signal strength. The processing unit displays the graphic representation in the user interface via the display unit.

In some embodiments, the visual representation manner comprises a size, a shape, a color, a brightness, and/or a twinkling state corresponding to the graphic representation. In some embodiments, when the signal strength is a first value, the size of the graphic representation is set to a first size. When the signal strength is a second value, the size of the graphic representation is set to a second size. When the first value is greater than the second value, the first size is greater than the second size.

In some embodiments, it is determined whether the signal strength corresponding to the specific electronic device is greater than a threshold value. When the signal strength corresponding to the specific electronic device is not greater than the threshold value, the graphic representation corresponding to the specific electronic device is not displayed in the user interface. In some embodiments, when the signal strength corresponding to the specific electronic device is greater than the threshold value, the visual representation manner of the graphic representation corresponding to the specific electronic device is set as a first specific manner, and the graphic representation is displayed via the user interface. In some embodiments, a target electronic device is determined from the at least one specific electronic device, wherein the wireless signal of the target electronic device has the greatest signal strength of all other specific electronic devices. The visual representation manner of the graphic representation corresponding to the target electronic device is set as a second specific manner, and the graphic representation corresponding to the target electronic device is displayed via the user interface, wherein the second specific manner and the first specific manner are different.

In some embodiments, location information corresponding to the electronic device is obtained, and location information corresponding to the specific electronic device is obtained. The display position for the graphic representation corresponding to the specific electronic device in the user interface is determined according to the location information corresponding to the electronic device and the location information corresponding to the specific electronic device.

In some embodiments, location information corresponding to at least three reference electronic devices among the at least one specific electronic device is obtained. The display position for the graphic representation corresponding to the respective reference electronic device in the user interface is determined according to the location information corresponding to the respective reference electronic device and the signal strength of the wireless signal corresponding to the respective reference electronic device.

In some embodiments, the user interface is divided into a plurality of partitions, and the graphic representation corresponding to the respective reference electronic device is displayed in one of the partitions of the user interface.

Methods for displaying graphic representations in a user interface may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a system for displaying graphic representations in a user interface of the invention;

FIG. 2 is a schematic diagram illustrating another embodiment of a system for displaying graphic representations in a user interface of the invention;

FIG. 3 is a flowchart of an embodiment of a method for displaying graphic representations in a user interface of the invention;

FIG. 4 is a flowchart of another embodiment of a method for displaying graphic representations in a user interface of the invention;

FIG. 5 is a flowchart of an embodiment of a method for setting the size of a graphic representation of the invention;

FIGS. 6A and 6B are schematic diagrams illustrating examples of graphic representations displayed in a user interface of the invention;

FIG. 7 is a flowchart of an embodiment of a method for determining a display position corresponding to a graphic representation of the invention;

FIG. 8 is a schematic diagram illustrating an example of graphic representations displayed in a user interface of the invention;

FIG. 9 is a flowchart of another embodiment of a method for determining a display position corresponding to a graphic representation of the invention;

FIG. 10 is a schematic diagram illustrating an example of graphic representations displayed in a user interface of the invention; and

FIG. 11 is a schematic diagram illustrating another example of graphic representations displayed in a user interface of the invention.

### DETAILED DESCRIPTION OF THE INVENTION

Methods and systems for displaying graphic representations in a user interface are provided.

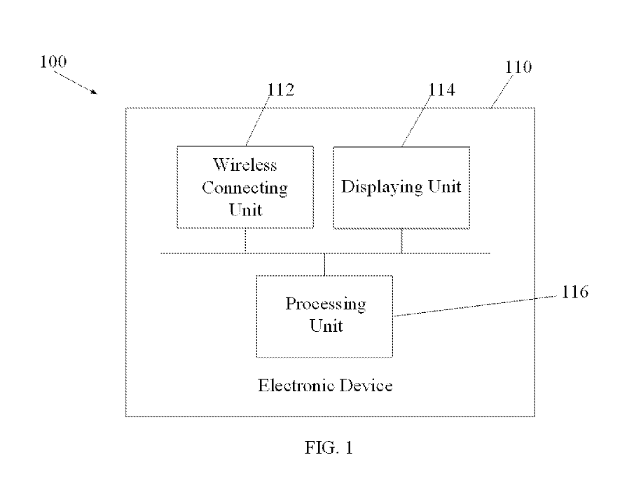

FIG. 1 is a schematic diagram illustrating an embodiment of a system for displaying graphic representations in a user interface of the invention. The system for displaying graphic representations in a user interface 100 can be used in an electronic device 110, such as a mobile phone, a smart phone, a PDA (Personal Digital Assistant), a GPS (Global Positioning System), a tablet computer, a wearable electronic device, or other portable device. As shown in FIG. 1, the electronic device 110 comprises a wireless connecting unit 112, a display unit 114, and a processing unit 116. The wireless connecting unit 112 can connect to other electronic devices having wireless connecting capabilities via a wireless network, such as Wi-Fi or Bluetooth network. The display unit 114 can display related information, such as texts, images, and/or interfaces. The processing unit 116 can control related operations of hardware and software in the electronic device 110, and perform the methods for displaying graphic representations in a user interface of the invention. This will be discussed further in the following paragraphs.

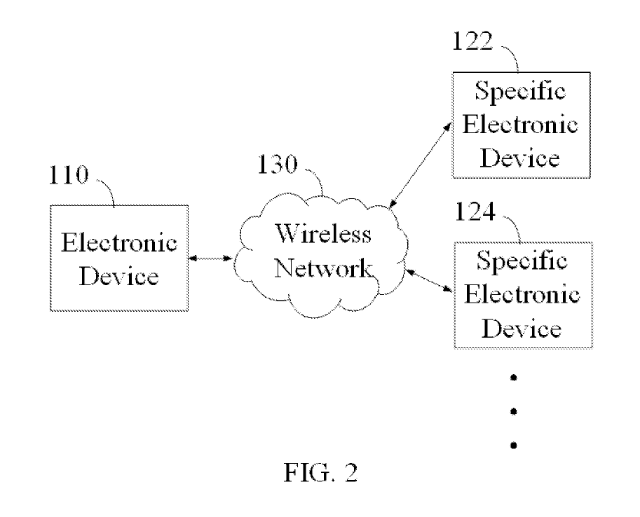

FIG. 2 is a schematic diagram illustrating another embodiment of a system for displaying graphic representations in a user interface of the invention. The system for displaying graphic representations in a user interface comprises an electronic device 110 and a plurality of specific electronic device (122, 124). In some embodiments, the electronic device 110 may be a portable device, such as a mobile phone, a smart phone, a PDA, a GPS, a tablet computer, or a wearable electronic device. It is understood that, the electronic device 110 and the respective specific electronic device can have wireless connecting capabilities. In some embodiments, the respective specific electronic device can connect to the electronic device 110 via a wireless network 130, such as Wi-Fi or Bluetooth network. It is noted that, in some embodiments, the specific electronic device may be a device having BLE wireless transmission capabilities, such as a beacon device, which continuously transmits a wireless signal.

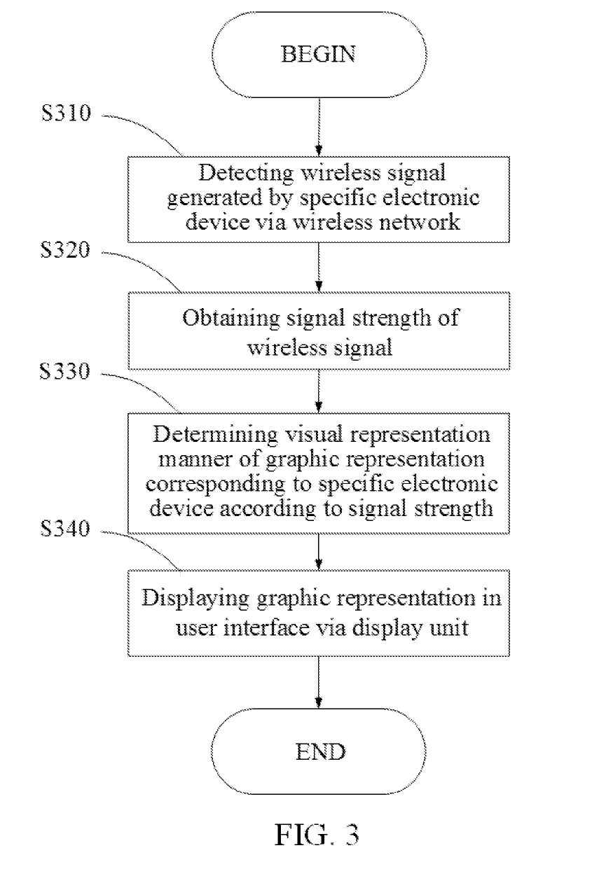

FIG. 3 is a flowchart of an embodiment of a method for displaying graphic representations in a user interface of the invention. The method for displaying graphic representations in a user interface can be used in an electronic device, such as a mobile phone, a smart phone, a PDA, a GPS, a tablet computer, a wearable electronic device, or other portable device.

In step S310, the electronic device detects a wireless signal generated by at least one specific electronic device via a wireless network, such as Wi-Fi or Bluetooth network. It is noted that, in some embodiments, the specific electronic device may be a device having BLE wireless transmission capabilities, such as a beacon device, which continuously transmits a wireless signal. Then, in step S320, a signal strength of the wireless signal is obtained. It is noted that, the signal strength of the wireless signal can be determined according to the RSSI (Received Signal Strength Indication) recorded in the wireless signal. Then, in step S330, a visual representation manner of a graphic representation corresponding to the specific electronic device is determined according to the signal strength. It is understood that, in some embodiments, the visual representation manner comprises a size, a shape, a color, a brightness, and/or a twinkling state corresponding to the graphic representation. It is understood that, in some embodiments, the size of the graphic representation is bigger when the signal strength is higher. For example, when the signal strength is a first value, the size of the graphic representation is set to a first size. When the signal strength is a second value, the size of the graphic representation is set to a second size. When the first value is greater than the second value, the first size is greater than the second size. In some embodiments, the shape of the graphic representation will be changed when the signal strength changes. In some embodiments, the color of the graphic representation will be changed when the signal strength changes. In some embodiments, the brightness of the graphic representation is higher when the signal strength is higher. In some embodiments, the twinkling frequency of the graphic representation is higher when the signal strength is higher. It is understood that, the above visual representation manners are only examples of the present application. Any manner that allows users to visually distinguish the difference between the graphic representations can be applied in the present invention. After the visual representation manner corresponding to the graphic representation is determined, in step S340, the graphic representation corresponding to the specific electronic device is displayed in a user interface via a display unit of the electronic device. It is understood that, when wireless signals corresponding to several specific electronic devices are detected by the electronic device, the graphic representations corresponding to the respective specific electronic devices are displayed in the user interface.

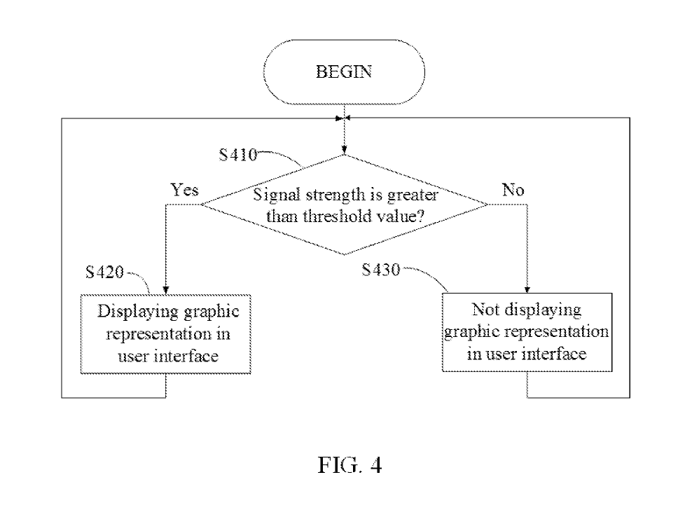

FIG. 4 is a flowchart of another embodiment of a method for displaying graphic representations in a user interface of the invention. The method for displaying graphic representations in a user interface can be used in an electronic device, such as a mobile phone, a smart phone, a PDA, a GPS, a tablet computer, a wearable electronic device, or other portable device.

In step S410, it is determined whether the signal strength corresponding to a specific electronic device is greater than a threshold value. When the signal strength corresponding to the specific electronic device is greater than the threshold value (Yes in step S410), in step S420, the graphic representation corresponding to the specific electronic device is displayed in the user interface. It is noted that, the size of the graphic representation corresponding to the specific electronic device can be determined according to the signal strength. When the signal strength corresponding to the specific electronic device is not greater than the threshold value (No in step S410), in step S430, the graphic representation corresponding to the specific electronic device is not displayed in the user interface. In other words, only the graphic representation corresponding to the specific electronic device having a signal strength greater than the threshold value will be displayed in the user interface.

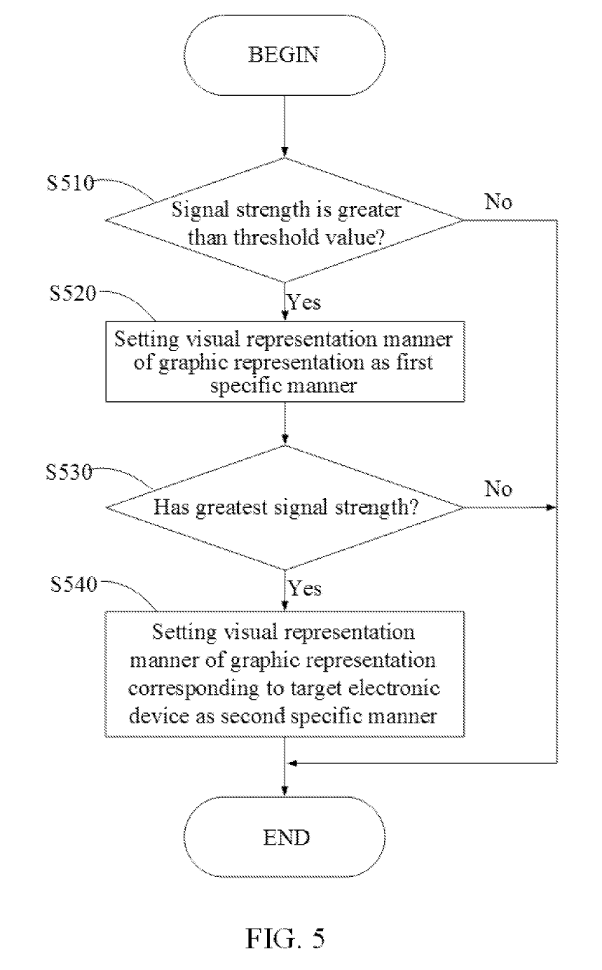

FIG. 5 is a flowchart of an embodiment of a method for setting the size of a graphic representation of the invention. The method for setting the size of a graphic representation can be used in an electronic device, such as a mobile phone, a smart phone, a PDA, a GPS, a tablet computer, a wearable electronic device, or other portable device.

In step S510, it is determined whether the signal strength corresponding to a specific electronic device is greater than a threshold value. When the signal strength corresponding to the specific electronic device is not greater than the threshold value (No in step S510), the procedure is completed. When the signal strength corresponding to the specific electronic device is greater than the threshold value (Yes in step S510), in step S520, the visual representation manner of a graphic representation corresponding to the specific electronic device is set as a first specific manner. In step S530, it is determined whether the wireless signal of the specific electronic device has the highest signal strength of all other devices. When the wireless signal of the specific electronic device does not have the highest signal strength of all other devices (No in step S530), the procedure is completed. When the wireless signal of the specific electronic device has the highest signal strength of all other devices (Yes in step S530), in step S540, the specific electronic device is set as a target electronic device, and the visual representation manner of the graphic representation corresponding to the target electronic device is set as a second specific manner. It is noted that, as described, in some embodiments, the visual representation manner comprises a size, a shape, a color, a brightness, and/or a twinkling state corresponding to the graphic representation. In some embodiments, the second specific manner and the first specific manner are different. For example, when the visual representation manner comprises the size of the graphic representation, the size of the graphic representation corresponding to the respective device having a signal strength greater than the threshold value can be set as a first specific size, and the size of the graphic representation corresponding to the device having the greatest signal strength can be set as a second specific size, wherein the second specific size is bigger than the first specific size. It is understood that, in some embodiments, when the greatest signal strength cannot be identified, a target electronic device can be determined from the devices according to a specific selection logic, and the visual representation manner of the graphic representation corresponding to the target electronic device can be set as the second specific manner. It is noted that, in some embodiments, the selection logic can determine whether the respective device is recorded in a specific list. For example, the specific list can record the devices which are registered or advertised, and/or have a specific ranking.

It is understood that, in some embodiments, when several devices simultaneously have a signal strength greater than the threshold value, a target electronic device can be directly determined from the devices according to a specific selection logic, and the visual representation manner of the graphic representation corresponding to the target electronic device can be set as a unique manner other than that of other devices. Similarly, in some embodiments, the selection logic can determine whether the respective device is recorded in a specific list. For example, the specific list can record the devices which are registered or advertised, and/or have a specific ranking.

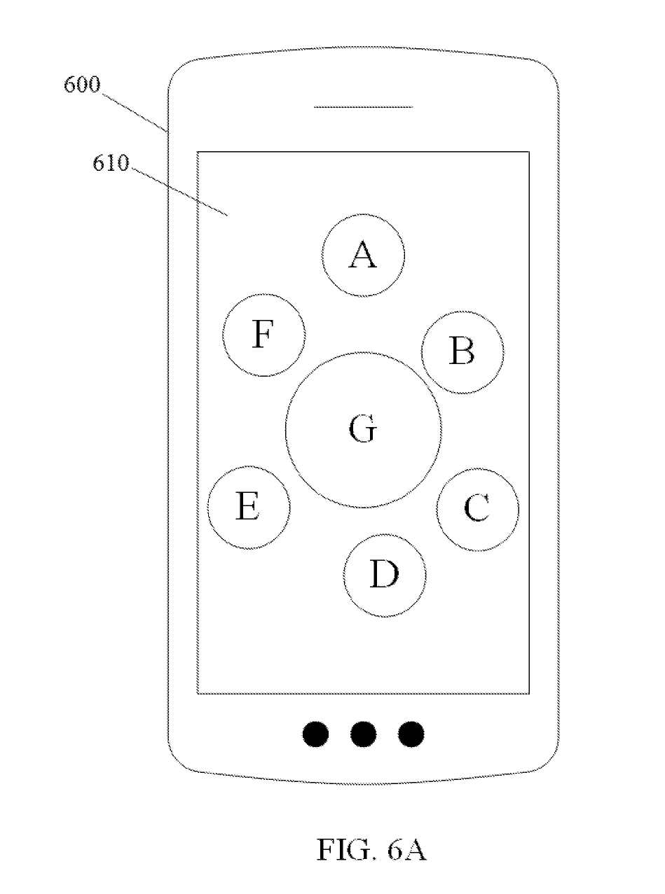

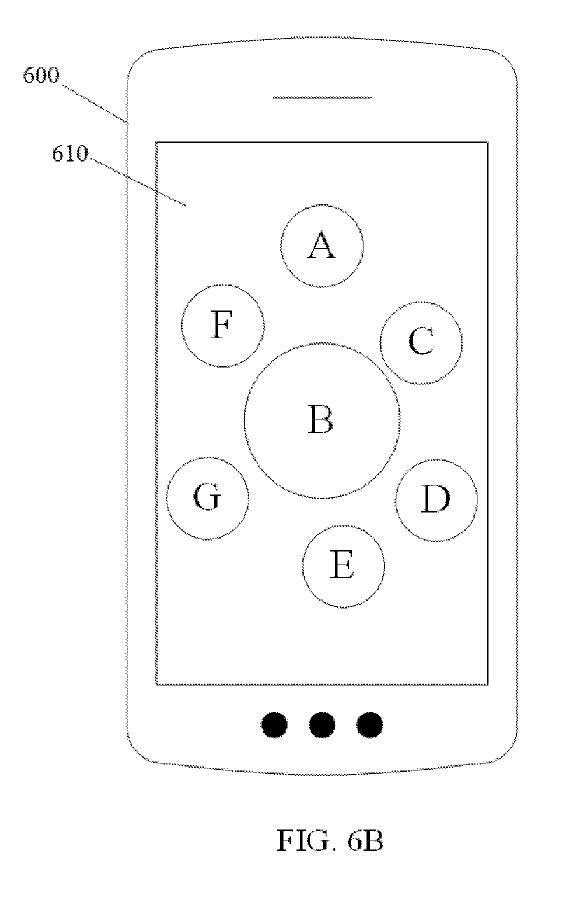

FIGS. 6A and 6B are schematic diagrams illustrating examples of graphic representations displayed in a user interface of the invention. In the examples, the visual representation manner is the size of the graphic representation. In FIG. 6A, wireless signals respectively corresponding to beacon devices A˜G are detected by a smart phone 600, wherein the signal strength of the wireless signal respectively corresponding to beacon devices A˜G is greater than a threshold value, and beacon device G has the greatest signal strength. The smart phone 600 can display a user interface 610. The user interface 610 includes graphic representations, with a first size, corresponding to beacon devices A˜F, and a graphic representation, with a second size, corresponding to beacon device G. It is understood that, in some embodiments, the graphic representation corresponding to beacon device G can be displayed at the center of the user interface 610. When the smart phone 600 moves away from beacon G and closer to beacon B, causing the signal strength of the wireless signal corresponding to beacon G to decrease, and the signal strength of the wireless signal corresponding to beacon B becomes the greatest signal strength among all of the beacon devices, the size of the graphic representation corresponding to beacon device B is changed from the first size to the second size, and the graphic representation corresponding to beacon device B is displayed at the center of the user interface 610. At this time, the size of the graphic representation corresponding to beacon device G is changed from the second size to the first size, as shown in FIG. 6B.

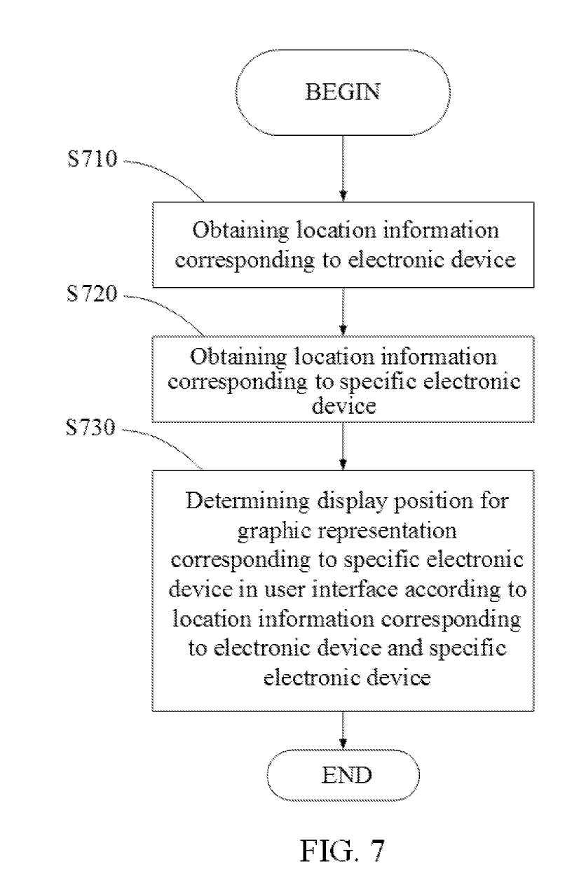

FIG. 7 is a flowchart of an embodiment of a method for determining a display position corresponding to a graphic representation of the invention. The method for determining a display position corresponding to a graphic representation can be used in an electronic device, such as a mobile phone, a smart phone, a PDA, a GPS, a tablet computer, a wearable electronic device, or other portable device.

In step S710, location information, such as longitude and latitude information corresponding to the electronic device is obtained. In step S720, location information, such as longitude and latitude information corresponding to a specific electronic device is obtained. Then, in step S730, the display position for a graphic representation corresponding to the specific electronic device in the user interface is determined according to the location information corresponding to the electronic device and the location information corresponding to the specific electronic device. It is noted that, the relative position between the electronic device and the specific electronic device can be determined according to the location information of the electronic device and the specific electronic device.

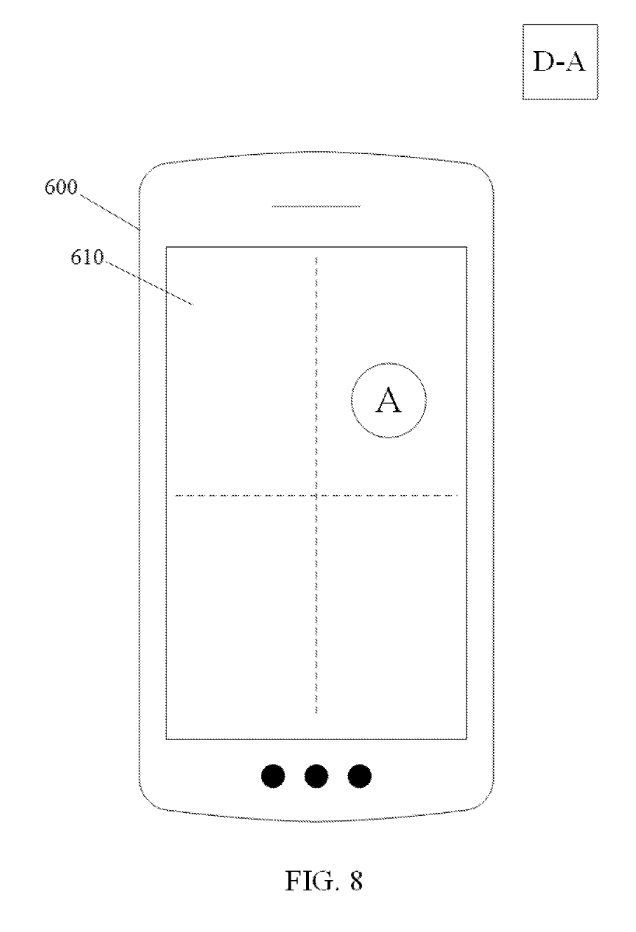

In some embodiments, the default position of the electronic device can be at the center of the user interface. When the specific electronic device is at a first direction, such as in the front of the electronic device, the graphic representation corresponding to the specific electronic device can be displayed in the topside of the user interface. When the specific electronic device is at a second direction, such as in the rear of the electronic device, the graphic representation corresponding to the specific electronic device can be displayed in the bottomside of the user interface. In another embodiment, the user interface can be divided into a plurality of partitions, and the graphic representation corresponding to the respective reference electronic device can be displayed in one of the partitions of the user interface. For example, when a specific electronic device D-A is at the right-front of the smart phone 600, the graphic representation corresponding to the specific electronic device D-A can be displayed in the top-right partition of the user interface 610, as shown in FIG. 8. It is noted that, the above display manners are only examples of the present application, and the present invention is not limited thereto.

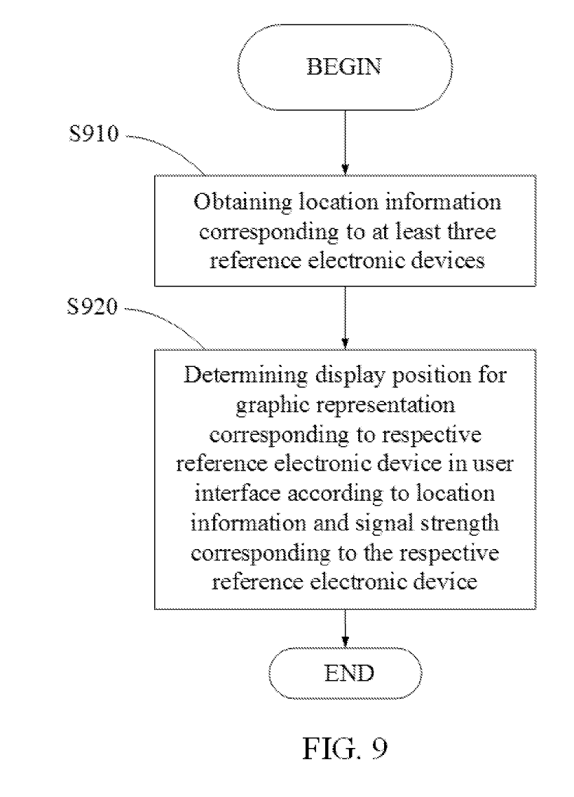

FIG. 9 is a flowchart of another embodiment of a method for determining a display position corresponding to a graphic representation of the invention. The method for determining a display position corresponding to a graphic representation can be used in an electronic device, such as a mobile phone, a smart phone, a PDA, a GPS, a tablet computer, a wearable electronic device, or other portable device.

In step S910, location information corresponding to at least three reference electronic devices is obtained. It is understood that, in some embodiments, the location information corresponding to the reference electronic device can be set according to its actual location and a coordinate system. Then, in step S920, the display position for a graphic representation corresponding to the respective reference electronic device in the user interface is determined according to the location information corresponding to the respective reference electronic device and the signal strength of the wireless signal corresponding to the respective reference electronic device.

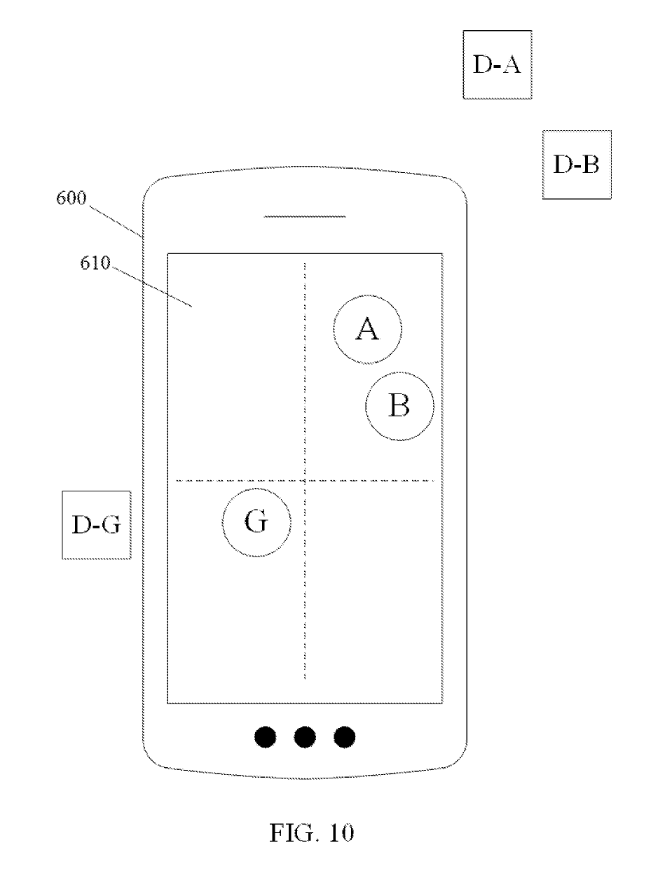

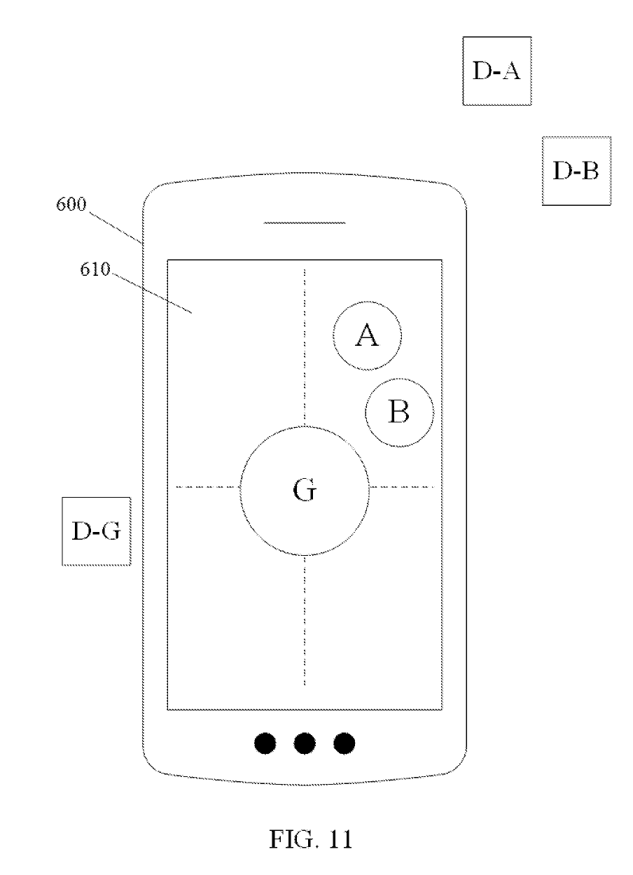

For example, specific electronic devices D-A, D-B and D-G can respectively set its location information according to a coordinate system. When the wireless signals respectively corresponding to the specific electronic devices D-A, D-B and D-G are detected by the smart phone 600, the relative position between the smart phone 600 and the specific electronic devices D-A, D-B and D-G can be determined according to the location information and the signal strength respectively corresponding to the specific electronic devices. In the example of FIG. 10, the smart phone 600 can know that the specific electronic devices D-A and D-B are at the right-front of the smart phone 600, and know that the specific electronic device D-G are at the left-rear of the smart phone 600. Consequently, the graphic representation corresponding to the specific electronic devices D-A and D-B are displayed in the top-right partition of the user interface 610, and the graphic representation corresponding to the specific electronic device D-G is displayed in the bottom-left partition of the user interface 610. As described, in some embodiments, the graphic representation corresponding to a specific electronic device having the greatest signal strength can be displayed, with a bigger size, at the center of the user interface. In the example, when the specific electronic device D-G has the greatest signal strength, the graphic representation corresponding to the specific electronic device D-G is displayed at the center of the user interface 610, as shown in FIG. 11. Similarly, the above display manners are only examples of the present application, and the present invention is not limited thereto. It is noted again, the above size of the graphic representations is only one of the examples of the visual representation manner, and any manner that users can visually know the difference between the graphic representations can be applied in the present invention.

Therefore, the methods and systems for displaying graphic representations in a user interface of the present invention can represent a specific electronic device in a user interface according to the wireless signal generated by the specific electronic device. Users can know the distance and relative position between the specific electronic device and users' electronic device via the visual representation manner and position corresponding to a graphic representation in the user interface, thereby enhancing the applicability of related devices and services.

Methods for displaying graphic representations in a user interface may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A method for displaying graphic representations in a user interface for use in an electronic device, comprising:
detecting a wireless signal generated by at least one specific electronic device via a wireless network;
obtaining a signal strength of the wireless signal;
determining a visual representation manner of a graphic representation corresponding to the specific electronic device according to the signal strength; and
displaying the graphic representation in a user interface via a display unit.

2. The method of claim 1, wherein the visual representation manner comprises a size, a shape, a color, a brightness, or a twinkling state corresponding to the graphic representation.

3. The method of claim 2, wherein when the signal strength is a first value, the size of the graphic representation is set to a first size, when the signal strength is a second value, the size of the graphic representation is set to a second size, wherein when the first value is greater than the second value, the first size is greater than the second size.

4. The method of claim 1, further comprising a step of determining whether the signal strength corresponding to the specific electronic device is greater than a threshold value, wherein when the signal strength corresponding to the specific electronic device is not greater than the threshold value, the graphic representation corresponding to the specific electronic device is not displayed in the user interface.

5. The method of claim 4, further comprising a step of when the signal strength corresponding to the specific electronic device is greater than the threshold value, setting the visual representation manner of the graphic representation corresponding to the specific electronic device as a first specific manner, and displaying the graphic representation via the user interface.

6. The method of claim 5, further comprising:
determining a target electronic device from the at least one specific electronic device, wherein the wireless signal of the target electronic device has the greatest signal strength of all other specific electronic devices; and
setting the visual representation manner of the graphic representation corresponding to the target electronic device as a second specific manner, and displaying the graphic representation corresponding to the target electronic device via the user interface, wherein the second specific manner and the first specific manner are different.

7. The method of claim 1, further comprising:
obtaining location information corresponding to the electronic device;
obtaining location information corresponding to the at least one specific electronic device; and
determining the display position for the graphic representation corresponding to the specific electronic device in the user interface according to the location information corresponding to the electronic device and the location information corresponding to the specific electronic device.

8. The method of claim 1, further comprising:
obtaining location information corresponding to at least three reference electronic devices among the at least one specific electronic device; and
determining the display position for the graphic representation corresponding to the respective reference electronic device in the user interface according to the location information corresponding to the respective reference electronic device and the signal strength of the wireless signal corresponding to the respective reference electronic device.

9. The method of claim 7, wherein the user interface is divided into a plurality of partitions, and the graphic representation corresponding to the respective reference electronic device is displayed in one of the partitions of the user interface.

10. The method of claim 8, wherein the user interface is divided into a plurality of partitions, and the graphic representation corresponding to the respective reference electronic device is displayed in one of the partitions of the user interface.

11. A system for displaying graphic representations in a user interface for use in an electronic device, comprising:
a display unit displaying a user interface;
a wireless connecting unit detecting a wireless signal generated by at least one specific electronic device via a wireless network; and
a processing unit obtaining a signal strength of the wireless signal, determining a visual representation manner of a graphic representation corresponding to the specific electronic device according to the signal strength, and displaying the graphic representation in the user interface via the display unit.

12. A machine-readable storage medium comprising a computer program, which, when executed, causes a device to perform a method for displaying graphic representations in a user interface, wherein the method comprises:
detecting a wireless signal generated by at least one specific electronic device via a wireless network;
obtaining a signal strength of the wireless signal;
determining a visual representation manner of a graphic representation corresponding to the specific electronic device according to the signal strength; and
displaying the graphic representation in a user interface via a display unit.
